(19) United States
(12) Patent Application Publication
(10) Pub. No.: US 2023/0240295 A1
(43) Pub. Date: Aug. 3, 2023

(54) METHOD OF AND A COMPOSITION FOR PROTECTING PLANTS AGAINST PLANT PATHOGENS

(71) Applicant: Suntton Company Limited, Wan Chai (CN)

(72) Inventors: Liping Peng, Sacramento, CA (US); Xi Wang, Chilliwack (CA)

(21) Appl. No.: 18/084,399

(22) Filed: Dec. 19, 2022

Related U.S. Application Data
(60) Provisional application No. 63/300,986, filed on Jan. 19, 2022.

(51) Int. Cl. A01N 43/22; A01N 43/16; A01N 25/04; A01P 3/00

(52) U.S. Cl. CPC A01N 43/22; A01N 25/04; A01N 43/16; A01P 3/00

(57) ABSTRACT

This disclosure includes a method of protecting crops from a variety of fungal, bacterial and viral diseases, especially from Cercospora leaf spots, downy mildews, powdery mildews and Botrytis diseases by the seed treatment and/or irrigation and/or the foliar application of multiple components compositions. The compositions contain at least two elicitors of systemic plant self-defenses, including RBs and Chitin or Chitosan or their derivatives.

### CROSS-REFERENCE TO RELATED APPLICATION(S)

This application claims priority under 35 U.S.C. § 119(e) of the U.S. Provisional Pat. Application Ser. No. 63/300,986, filed Jan. 19, 2022 and titled, “A Method OF And A Composition For Protecting Plants Against Plant Pathogens,” which is also hereby incorporated by reference in its entirety for all purposes.

### FIELD OF THE INVENTION

The present invention relates to a method of and a composition for protecting plants against fungal, bacterial and viral diseases. More specifically, the present invention relates to protecting crops from Cercospora leaf spot, downy mildew, powdery mildew and Botrytis diseases.

### BACKGROUND OF THE INVENTION

Crops often suffer from a variety of fungal, bacterial and viral diseases such as Cercospora leaf spot diseases, downy mildews, powdery mildews, and botrytis diseases. The frequent use of conventional fungicides causes the problem of fungicides resistance.

### SUMMARY OF THE INVENTION

Disclosed herein is a method of and composition for protecting plants against a variety of fungal, bacterial and viral diseases, especially against Cercospora leaf spot, downy mildew, powdery mildew, and botrytis diseases. The composition contains Brassinosteroids, Chitin, Chitosan, and/or their derivatives. In some embodiments, some or all of substances used are naturally produced and are safe to crops and the environment.

Brassinosteroids (BRs) are naturally occurring substance and present in higher plants and lower plants. BRs work as an elicitor of plant’s self defense mechanisms against plant diseases (e.g., fungal diseases, Cercospora leaf spot, downy mildew, powdery mildew and Botrytis diseases), and commercially available BRs, such as 24-epibrassinolide are found eliciting self-defense to plants.

Various microbes, including fungi, produce Chitin and Chitosan. Plants recognize the fragments of Chitin and Chitosan and trigger plant’s systemic defense responses and controlled expending of fungal spreading but using Chitin and Chitosan alone would not provide excellent results as chemical fungicides.

Both Chitin, Chitosan and brassinolide do not have fungicide resistance issue due to their action modes. In some embodiments, the compositions provide synergetic effects in terms of providing more effective protection with both concurrent eliciting self-defense and fungal control mechanism to crops.

The present disclosure provides methods of treating crops, which suffer from various of diseases, especially from Cercospora leaf spot diseases, downy mildews, powdery mildews, and botrytis diseases, and add an optional tool for the fungicide resistance management.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a method of protecting plants against fungal, bacterial and viral diseases according to some embodiments.

FIG. 2 illustrates another method of protecting plants against fungal, bacterial and viral diseases according to some embodiments.

### DETAILED DESCRIPTION OF THE PREFERRED EMBODIMENT

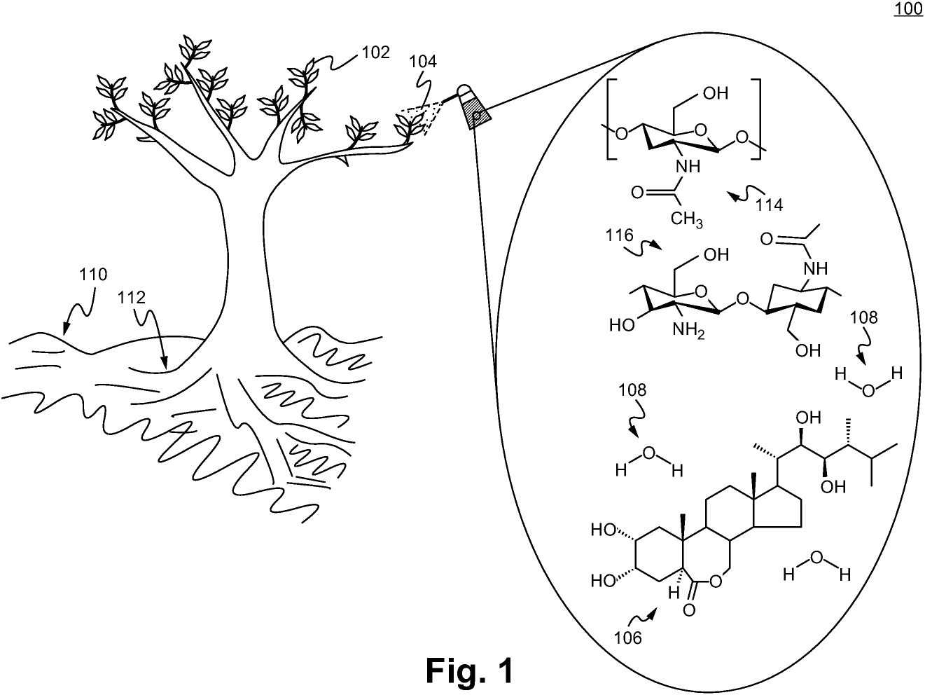

FIG. 1 illustrates a plant protecting method 100 against fungal, bacterial and viral diseases according to some embodiments. In some embodiments, a water solution 104 is applied on leaves 102 or roots 112 of a plant. In some embodiments, a water solution 104 is applied to soil 110 near or around the plant. In some embodiments, the water solution 104 comprises water 108 and one or more active compounds from brassinosteroids 106. In some embodiments, the one or more active compounds comprise 24-epibrassinolide. In some embodiments, the one or more active compounds comprise Chitin 114, Chitin’s derivatives, Chitosan 116, or Chitosan’s derivatives. In some embodiments, the one or more active compounds comprise 24-epibrassinolide 106, Chitin, Chitin’s derivatives, Chitosan, Chitosan’s derivatives, or a combination thereof.

In some embodiments, the one or more active compounds comprise 24-epibrassinolide 106, Chitin, Chitin’s derivatives, Chitosan, Chitosan’s derivatives, or a combination thereof serving as major ingredients or the only active ingredients in the solution. Major ingredients can include the above mentioned ingredients that are more than 50% by weight of all of the ingredients in the solution. The application dosages and procedures are further described in the following disclosure.

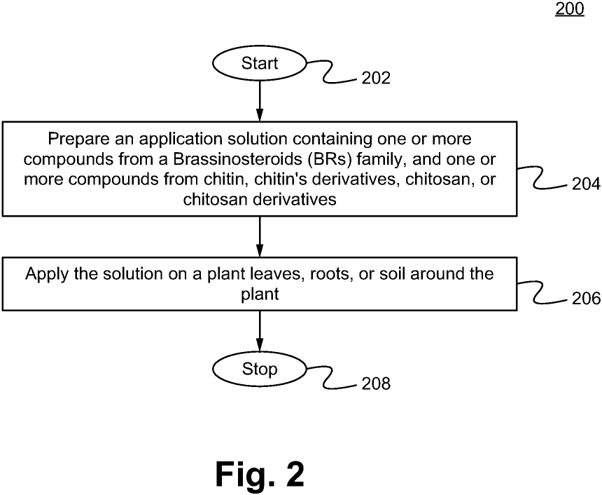

FIG. 2 illustrates another process 200 of protecting plants against fungal, bacterial and viral diseases according to some embodiments. The process 200 can start at a Step 202. At a Step 204, an application solution containing one or more compounds from a Brassinosteroids (BRs) family and one or more of a second components selected from a group of Chitin, Chitin’s derivatives, Chitosan, or Chitosan’s derivatives. At a step 206, the solution is applied on a plant’s leaves, roots, or soil around the plant. The process 200 is able to stop at a Step 208.

In an aspect, the composition in accordance with some embodiments comprises one or more parts from Component 1 and one or more parts from Component 2. The term the composition used in the Present Disclosure can contain one or more ingredients or compounds.

The Components 1 and 2 include:

1) Component 1: one or more compounds selected from a group having a compound from Brassinosteroids (BRs) family Group B1- B9:

Group B1: a main carbon skeleton of structures has Norbrassinolide-type side chain, including:

28-Norbrassinolide, 28-Norcastasterone, 6-Deoxo-28-norcastasterone, 28-Nortyphasterol, 6-Deoxo-28-nortyphasterol, 28-Norteasterone, 6-Deoxo-28-norteasterone, 3-Dehydro-6-deoxo-28-norteasterone, and 26-Norcastasterone.

Group B2: a main carbon skeleton of structures has brassinolide-type side chain, including:

Brassinolide, Castasterone, 6-Deoxocastasterone, Typhasterol, Teasterone, 2-Epicastasterone, 3-Epicastasterone, 2,3-Diepicastasterone, 1β-Hydroxycastasterone, 1α-Hydroxy-3-epicastasterone, 3-Epi-6-deoxocastasterone, Teasterone-3-myristate, 3-Dehydroteasterone, Secasterone, 6-Deoxotyphasterol, 3-Dehydro-6-deoxoteasterone, 2-Deoxybrassinolide, Teasterone-3-laurate, 6-Deoxoteasterone, 6α-Hydroxycastasterone, 3-O-P-D-Glucopyranosylteasterone, 3-Epibrassinolide, 2,3-Diepisecasterone, Secasterol, Cryptolide, 23-Dehydro-2-epicastasterone, 3-Epi-2-deoxybrassinolide, and Castasterone 23-phosphate.

Group B3: a main carbon skeleton of structures has 24-Epibrassinolide-type side chain, including:

24-Epicastasterone, 3, 24-Diepicastasterone, 24-Epibrassinolide, 6-Deoxo-24-epicastasterone, and 24-Episecasterone.

Group B4: a main carbon skeleton of structures has Dolicholide-type side chain, including:

Dolicholide, Dolichosterone, and 6-Deoxodolichosterone.

Group B5: a main carbon skeleton of structures has 28-Homobrassinolide-type side chain, including:

28-Homocastasterone, 28-Homobrassinolide, 28-Homoteasterone, 28-Homotyphasterol, and 6-Deoxe-28-homotyphasterol.

Group B6: a main carbon skeleton of structure has 25-Homebrassinolide-type chain, including:

25-Methylcastasterone.

Group B7: a main carbon skeleton of structure has 28-Homodolicholide-type side chain, including:

28-Homodolicholide, 28-Homodolichosterone, and 6-Deoxo-28-homodolichosterone.

Group B8: a main carbon skeleton of structure has 25-Homodolicholide-type side chain, including:

25-Methyldolichosterone, 2-Deoxy-25-methyldolichosterone, 3-Epi-2-deoxy-25-methyldolichosterone, 2-Epi-25-methyldolichosterone, 2,3-Diepi-25-methyldolichosterone, 6-Deoxo-25-methyldolichosterone, 23-O-β-D-Glucopyranosyl-25-methyldolichosterone, and 23-O-β-D-Glucopyranosyl-2-epi-25-methyldolichosterone.

Group B9: miscellaneous, including:

Cathasterone, 28-Epihomobrassinolide, 22,23,24-Triepibrassinolide, 14-hydroxylated brassinosteroid, 22,23-Epoxybrassinosteroid-2,3-diacetates, and Biobras-16.

2) Component 2: one or more compounds selected from Group P1 and/or P2.

Group P1: Chitin and its derivatives, including Chitin, Chitin oligosacchrides and Chitin derivatives from acylation, alkylation, sulfation, hydroxylation, quaternization, sterification, graft copolymerization, and etherification.

Group P2: Chitosan and its derivatives, including Chitosan, chitosan oligosacchrides and Chitin derivatives from acylation, alkylation, sulfation, hydroxylation, quaternization, esterification, graft copolymerization, and etherification.

In an aspect, the composition in accordance with some embodiments comprises at least one part of Component 1 and at least one part of the Component 2.

In some embodiments, the Component 1 is/comprises 24-Epibrassinolide (EBR).

In some embodiments, the concentration of Component 1 in the application solution is in the range from 0.001 - 10 ppm. In some embodiments, the concentration of Component 1 in the application solution is in the range from 0.025 - 0.1 ppm.

In some embodiments, the concentration of Component 2 in the application solution is in the range from 1 - 100 ppm. In some embodiments, the concentration of Component 1 in the application solution is in the range from 10 - 80 ppm.

In some embodiments, the composition is prepared in common types of agrochemical formulations, such as solutions, emulsions, suspensions, dusts, powders, pastes, granules, pressings and capsules. The types of formulations can be defined in the “Catalogue of pesticide formulation types and international coding system,” Technical Monograph No. 2, 7^{th} Edition, Revised March 2017, CropLife International. The compositions are able to be prepared in a typical known chemical formulation preparation manner, such as described in the “Formulation technology” by Mollet and Grubemann, WILEY-VCH, 1^{st} Edition, 2001.

Crops in which the compositions are able to be used include, but not limited to, various vegetables (e.g., potato, sugar beet, onion, lettuce, broccoli, cabbage, bean, lentil, pea, soybean, cucumber, squash, watermelon, cantaloupe), citrus fruits (e.g., lemon, mandarin, orange), pome fruits (e.g., apple, pear), stone fruits (e.g., apricot, cherry, peach, plum), berries and small fruits (e.g., blueberry, raspberry, blackberry, grape, kiwifruit, strawberry), tree nuts (e.g., almond, pecan, walnut), cereal grains ( e.g., wheat, barley, corn, oats, rice, rye), cotton and oil crops (e.g., rape, sunflower).

In some embodiments, surfactants such as spreaders and penetration enhancers are added to the application solution to improve the efficacy. In some embodiments, surfactants used are naturally extracted chemicals, such as citrus oil and soaps or all natural extracted surfactants and penetrators. In some embodiments, surfactants used are synthesized chemicals, such as alkylphenol-alkylene oxide addition products, alcohol-alkylene oxide addition products, and organosilicone surfactants.

The application methods include seed treatment, irrigation and foliar applications.

In some embodiments, the solution/composition is applied as a seed treatment at the rate of 1.0-1.5 fl.oz per 100 lbs of seeds. In some embodiments, the solution/compositions is applied as a water-slurry through standard slurry or mist-type commercial seed treatment equipment or grower’s hopper box. In some embodiments, the slurry is composed of water or in combination with approved seed treatment fungicides, insecticides or plant nutritional products.

In some embodiments, the solution/composition is applied with irrigation water starting from seeding and after.

In some embodiments, the solution/composition is applied by foliar applications starting from the leaf development stage and after. Apply preventively before biotic stresses occur. More applications are able to be applied at 10-14 days intervals after the first two applications.

According to the invention, the composition is suitable for against a variety of phytopathogenic fungi, especially from the classes of Plasmodiophoromycetes, Oomycetes, Chytridiomycetes, Zygomycetes, Ascomycetes, Deuteromycetes and Basidiomycetes.

According to the invention, the composition is suitable for controlling the fungal diseases below:

Plasmodiophora spp., e.g., P. brassicae (clubroot); Polymyxa spp., e.g., P. graminis on cereals and transmit plant viruses; Spongospora spp., e.g., S. subterranea (powdery scab) on potatoes; Aphanomyces spp., e.g., A. euteiches (root rot) on peas; Pythium spp., (damping-off) on various plants; Phytophthora spp., (late blight) on potatoes, (root and stem rots, fruit rot) on various plants; Plasmopara spp., e.g. P. viticola (downy mildew) on grape; Peronospora spp., e.g., P. tabacina (downy mildew) on tobacco; Bremia spp., e.g., B. lactucae (downy mildew) on lettuce; Pseudoperonospora spp., e.g., P. cubensis (downy mildew) on cucurbits; Peronosclerospora spp., e.g. P. philippinensis (downy mildew) on corn, P. sacchari(downy mildew) on sugarcane and corn, P. sorghi (downy mildew) on sorghum; Sclerophthora spp., (crazy top/downy mildew) on corn; Albugo spp., e.g., A. candida (white rust) on crucifers; Physoderm spp., e.g., P. maydis (brown spot) on corn; Synchytrium spp., e.g., S. endobioticum on potatoes (potato wart); Blumeria spp., (powdery mildew) on cereals; Erysiphe spp., e.g., E. betae (powdery mildew) on sugar beets, E. cichoracearum (powdery mildew) on cucurbits, E. polygoni (powdery mildew) on legumes, E. heraclei ( powdery mildew) on carrot, parsley and celery; Leveillula spp., e.g., L. taurica (powdery mildew) on tomato; Microsphaera spp., e.g., M. diffusa (powdery mildew) on soybean; Oidium spp., (powdery mildew) on tomato; Podosphaera spp., e.g., P. leucotricha (powdery mildew) on apple; Sphaerotheca spp., e.g., S. pannosa (powdery mildew) on peach, S. fuliginea (powdery mildew) on cucurbits; Uncinula spp., e.g., U. necator(powdery mildew) on grape; Gibberella spp., (foot or stalk rot) on corn and small grains; Claviceps spp.,e.g., C. purpurea (ergot) on grain crops; Ceratocystis spp., e.g., C. fimbriata (canker) on stone fruit, (root rot) on sweet potato; Monosporascus spp., e.g., M. cannonballus (root rot and collapse) on cucurbits; Glomerella spp., e.g., G. cingulata (anthracnose canker, dieback, withertip, fruit rot) on a great may plant; Diaporthe spp., e.g., (damping-off) on soybean; Gnomonia spp., e.g., G.leptostyla (anthracnose and leaf spot) on walnut; Gaeumannomyces spp., e.g., G. graminis (take-all) on cereals and corn; Magnaporthe spp., e.g., M. grisea (rice blast) on rice; Leucostoma spp., (canker) on peach; Eutypa spp., e.g., E. armeniacae (canker) on fruit trees and vines; Mycosphaerella spp., e.g., M. musicola and M. fijiensis (leaf spots) on banana, M. graminicola (leaf spot) on cereals, M. fragariae (leaf spot) on strawberry; Elsinoe spp., e.g., E. fawcetti (scab) on citrus, E. ampelina (anthracnose) on grape, and E. veneta (anthracnose) on soft fruits; Cochliobolus (anamorph: Bipolaris or Curvularia) spp., (leaf spot and root rot) on grain crops; Pyrenophora (anamorph: Drechslera) spp., (leaf spot) on cereals; Setosphaera (anamorph: Exserohilum) spp.,, (leaf spot) on cereals; Leptosphaeria (anamorph:Phoma) spp., (black leg and foot rot) on cabbage; Venturia (anamorph: Pollaccia and Spilocaea) spp., e.g., V. inaequalis (scab) on apple and V. pyrina (scab) on pear; Guignardia (anamorph: Phyllosticta) spp., (black rot) on vines; Sclerotinia spp., e.g., S. sclerotiorum (white mold or watery soft rot) on vegetables and field crops; Verticillium spp., (vascular wilt) on many plants; Fusarium spp.,(vascular wilt, root rot, stem rot, seed infections) on various plants; Colletotrichum spp., (anthracnose) on various plants; Cercospora spp., e.g., C. zeae-maydis (grey leaf spots) on corn, C. beticola (cercospora leaf spot) on sugar beets, C. sojina (frog-eye leaf spot) on soybean; Septoria spp., (leaf spot) on various crops; Phyllosticta spp., ( black rot) on grape; Alternaria spp., e.g., A. brassicae or A. brassicicola (black leaf spot) on crucifers; Cladosporium spp., e.g., C. fulvum (leaf mold) on tomato,C. carpophilum (scab) on peach and almond; Botrytis spp., e.g B. cinerea (gray mold rot) on various plants; Rhizoctonia spp., on various plants, e.g., R. solani (root and stem rot) on soybean; Ustilago spp., e.g., U. maydis (smut) on corn, U.avenae (loose smut) on oats, U. nuda (loose smut) on barley and U. tritici (loose smut) on wheat;Tilletia spp., e.g., T. caries (covered smut or bunt) on wheat, T. indica (Kamal bunt) on wheat; Urocystis spp., e.g., U. magica (smut) on onion; Sphacelotheca spp., e.g., S. fuliginea (powdery mildew) on cucurbits; Phakopsora spp., e.g., P. pachyrrhizi (rust) on soybean; Puccinia spp., (rust) on cereals; Uromyces spp., e.g., U. appendiculatus (rust) on beans; Typhula spp., e.g., T. incamata (typhula blight/grey snow mold) on barley or wheat; turf grasses; and Corticium spp., e.g., C. sasakii (sheath blight) on rice.

According to some embodiments, the composition is suitable for against a broad spectrum of phytopathogenic bacteria, especially from classes of Proteobacteria, Firmibacteria, Thallobacteria and Mollicutes.

According to some embodiments, the composition is especially suitable for controlling the bacterial diseases below:

Erwinia spp., e.g., E. amylovora (fire blight) on pear and apple, E. carotovora (soft rot) on vegetables; Pantoea spp., e.g., P. stewartii(Stewart’s wilt) on corn; Serratia spp., e.g S. marcescens (yellow vine disease) on cucurbits; Acidovorax spp. (leaf spot) on corn and watermelon; Pseudomonas spp., (leaf spot, blight, vascular wilt soft rot, canker and gall) on various of plants;Ralstonia spp., e.g., R. pseudosolanacearum (wilt) on tomato and eggplant; Rhizomonas spp., e.g., R. suberifaciens (corky root) on lettuce; Xanthomonas spp., (leaf spot, fruit spot, and blight) on various plants, X. campestris pv. citri (canker) on citrus, X. campestris pv. Campestris, ( black rot or black vein) on cr ucifers; Agrobacterium spp., e.g., A. tumefaciens (crown gall) on stone fruits, pome fruits and grapes; Xylella spp., e.g., X. fastidiosa (Pierce′ s disease) on grape, (variegated chlorosis) on citrus; Candidatus spp., e.g., Ca. liberobacter (citrus greening disease) on citrus; Clavibacter spp., e.g., C. michiganense (ring rot) on potato and (canker and wilt) on tomato; Curtobacterium flaccumfaciens, (bacterial wilt) on bean; Leifsonia xyli subsp. Xyli (ratoon stunting disease) on sugarcane; Streptomyces scabies (common scab) on potato; Spiroplasmaspp., e.g., S. citri (stubborn) on citrus, and S. Kunkelii (stunt) on corn.

According to some embodiments, the composition is suitable for against a variety of phytopathogenic viruses, especially suitable for controlling the viral diseases below:

Tobamoviruses, e.g., tobacco mosaic virus on tobacco and solanaceous plants, tomato mosaic virus on tomato; Tobraviruses, e.g., tobacco rattle virus on tobacco, potato, pea early browning virus on peas and pepper ring spot virus on pepper; Furovirus, e.g., potato mop-top virus on potato, soil-borne wheat mosaic virus on wheat and barley; Hordeiviruses, e.g., barley stripe mosaic virus on grain crops; Pecluviruses, e.g., peanut clump virus on peanut; Pomoviruses, e.g., potato mop-top virus on potato; Benyviruses, e.g., beet necrotic yellow vein virus on sugar beet; Potexviruses, e.g., potato virus X on potato; Capilloviruses, e.g., apple stem grooving virus on apple and citrus; Trichoviruses, e.g., apple chlorotic leaf spot virus on pome and stone fruits; Foveaviruses, e.g., apple stem pitting virus on apple; Vitivirus, e.g., grapevine virus on grape; Potyviruses, e.g., potato virus Y on potato, bean yellow mosaic virus on pea, peanut, soybean, lettuce mosaic virus on lettuce, soybean mosaic virus on soybean; Tritimovirus, e.g., wheat streak mosaic virus on wheat, corn, rye, oats, barley and sorghum; Bymoviruses, barley yellow mosaic virus on barley; Closteroviruses, e.g. citrus tristeza virus on citrus, Beet yellows virus on sugar beet; Criniviruses, e.g., lettuce infectious yellows virus on lettuce; Machlomovirus e.g., maize chlorotic mottle virus on corn; Luteoviruses, e.g., barley yellow dwarf virus on barley, oat, wheat and rye,; Poleroviruses, e.g., potato leafroll virus on potato; Comoviruses, e.g., cowpea mosaic virus on legumes, squash mosaic virus on cucurbits; Nepoviruses, e.g., tomato ring spot virus on tomato, pome fruit, stone fruit and small fruits; Cucumoviruses, e.g., Cucumber mosaic virus on various plants; Ilarviruses, e.g., prunus necrotic ring spot virus on stone fruits; Tospoviruses, e.g., tomato spotted wilt virus on tomato, tobacco, peanut and lettuce; Tenuiviruses, e.g., rice stripe virus on rice and maize stripe virus on corn; Curtovirus, e.g., Beet curly top virus on sugar beet, bean, tomato, melons and spinach; Mastrevirus, e.g., maize streak virus on corn; and Begomovirus, e.g., bean golden mosaic virus on beans.

In utilization, the compositions disclosed here are used to treat fungi and bacterial diseases by eliciting plant’s self-defense mechanisms.

In operation, a solution is prepared comprising a first component selected from a group of a Brassinosteroids (BRs) family; one or more of a second components selected from a group of Chitin and its derivatives or Chitosan and its derivatives; and applying the solution in seed treatment and/or in soil and/or on leaves of a plant and eliciting the plant’s self-defense response to a pathogen.

### EXAMPLES

The disclosure is now further illustrated with reference to the following examples.

### Example 1

A table grape (Crimson seedless variety) trial is set up in University of California, REC to compare EBR+Chitosan to other fungicides treatments’ efficacy on Botrytis Bunch Rot. berry.

TABLE 1

Treatment Number, Fungicide ID, Spray Rate, Timing and Tank Mix Volume

| Trt. ID | Type | Name | Content (%) | Form Unit | Rate | Timing | Volume (gal/acre) |
|---|---|---|---|---|---|---|---|
| 0 | FUNG | EBR + Chitosan | EBR 0.01 Chitosan 5 | % w/w | EBR 0.2 PPM Chitosan 100 PPM | Before budbreak | 50 |
| | FUNG | EBR + Chitosan | | | EBR 0.1 PPM Chitosan 50 PPM | 7 days before bloom | |
| | FUNG | EBR + Chitosan | | | EBR 0.1 PPM Chitosan 50 PPM | Berry touch | |
| 1 | CHK | Untreated check | | | | | |
| 2 | FUNG | Pristine | 62 | % w/w | 23 oz/acre | Berry touch | 100 |
| | FUNG | Elevate | 50 | % w/w | 16 oz/acre | Veraison | 150 |
| 3 | FUNG | Switch | 62.5 | % w/w | 14 oz/acre | Bloom | 100 |
| | FUNG | Pristine | 62 | % w/w | 23 oz/acre | Berry touch | 100 |
| | FUNG | Elevate | 50 | % w/w | 16 oz/acre | Veraison | 150 |
| 4 | FUNG | Inspire Super | 2.82 | LBA/ GAL | 20 oz/acre | 7 days before bloom | 100 |
| | FUNG | Switch | 62.5 | % w/w | 14 oz/acre | Bloom | 100 |
| | FUNG | Pristine | 62 | % w/w | 23 oz/acre | Berry touch | 100 |
| | FUNG | Elevate | 50 | % w/w | 16 oz/acre | Veraison | 150 |
| 5 | FUNG ADJ | ASFBIOF 01-02 Activator 90 | 15 90 | % w/w | 48 oz/acre 16 oz/100 gal | 7 days before bloom | 100 |
| | FUNG | Switch | 62.5 | % w/w | 14 oz/acre | Bloom | 100 |
| | FUNG | Pristine | 62 | % w/w | 23 oz/acre | Berry touch | 100 |
| | FUNG | Elevate | 50 | % w/w | 16 oz/acre | Veraison | 150 |
| 6 | FUNG ADJ | ASFBIOF 01-02 Activator 90 | 15 90 | % w/w | 48 oz/acre 16 oz/100 gal | Bloom | 100 |
| | FUNG | Pristine | 62 | % w/w | 23 oz/acre | Berry touch | 100 |
| | FUNG | Elevate | 50 | % w/w | 16 oz/acre | Veraison | 150 |
| 7 | FUNG ADJ | Serenade Activator 90 | 26.2 90 | % w/w | 14 oz/acre 16 oz/100 gal | 7 days before bloom | 100 |
| | FUNG | Switch | 62.5 | % w/w | 14 oz/acre | Bloom | 100 |
| | FUNG | Pristine | 62 | % w/w | 23 oz/acre | Berry touch | 100 |
| | FUNG | Elevate | 50 | % w/w | 16 oz/acre | Veraison | 150 |
| 8 | FUNG ADJ | Serenade Activator 90 | 26.2 90 | % w/w | 14 oz/acre 16 oz/100 gal | Bloom | 100 |
| | FUNG | Pristine | 62 | % w/w | 23 oz/acre | Berry touch | 100 |
| | FUNG | Elevate | 50 | % w/w | 16 oz/acre | Veraison | 150 |

* FUNG - Fungicide; ADJ - Adjuvant; EBR - 24-epibrassinolide; Switch - Cyprodinil 37.5%, Fludioxonil 25%; Pristine - Boscalid 25.2%, Pyraclostrobin 12.5%; Elevate - Fenhexamid 50% Inspire Super - Difenoconazole 86 g/L, Cyprodinil 249 g/L; Serenade - QST 713 strain of Bacillus subtilis.

TABLE 2

Botrytis bunch rot incidence rate on September 14^{th} and October 17^{th}

| Treatment ID | Flagging Tape Color ID | Incidence rate (%) | |
|---|---|---|---|
| | | Sep.14 | Oct. 17 |
| 0 | Blue | 69.4 bc* | 86.6 ab |
| 1 | White (untreated control) | 89.3 a | 96.7 a |
| 2 | Yellow/black dots | 79.0 ab | 86.7 ab |
| 3 | Green | 49.1 d | 72.2 b |
| 4 | Yellow | 56.5 cd | 70.2 b |
| 5 | Red | 66.5 bc | 80.7 b |
| 6 | Orange check | 74.2 bc | 88.0 ab |
| 7 | Purple | 59.7 cd | 75.6 b |
| 8 | Red dots | 74.2 bc | 88.2 ab |

* Different letters within columns represent the significant differences according to the Tukey’s HSD at p <0.05

The results shows that the treatment 0 with EBR at 0.1-0.2 ppm and Chitosan at 50-100 ppm were significantly lower than untreated control 1(UTC) in terms of incidence rate in the first rating on Sep. 14, and numerically lower than UTC in the second rating on Oct. 17. Also, the EBR+Chitosan treatment 0 shows similar efficacy as some commercial fungicides treatments 2, 6, 8.

TABLE 3.

Botrytis bunch rot severity rate on September 14^{th} and October 17^{th}

| Treatment ID | Flagging Tape Color ID | Severity rate (%) | |
|---|---|---|---|
| | | Sep. 14 | Oct. 17 |
| 0 | Blue | 29.5 bc* | 38.6 bc |
| 1 | White (untreated control) | 54.4 a | 70.1 a |
| 2 | Yellow/black dots | 31.0 b | 47.6 b |
| 3 | Green | 10.6 d | 15.2 d |
| 4 | Yellow | 18.8 bcd | 20.1 d |
| 5 | Red | 14.3 cd | 18.7 d |
| 6 | Orange check | 27.8 bc | 39.1 bc |
| 7 | Purple | 22.7 bcd | 27.8 cd |
| 8 | Red dots | 26.8 bc | 37.8 bc |

*Different letters within columns represent the significant differences according to the Tukey’s HSD at p <0.05

The results shows that the treatment 0 with EBR at 0.1-0.2 ppm and Chitosan at 50-100 ppm were significantly lower than untreated control 1 (UTC) in terms of severity rate in the second rating on Oct. 17. Also, the EBR+Chitosan treatment 0 shows similar efficacy as some commercial fungicides treatments 2, 6, 7, 8.

We claim:

1. A method of protecting plants from fungal, bacterial and viral diseases comprising:
(a) preparing a solution comprising:
i) a first component selected from a group of a Brassinosteroids (BRs) family;
ii) one or more of a second components selected from a group of Chitin, Chitin’s derivatives, Chitosan, or Chitosan’s derivatives; and
(b) applying the solution in soil or on leaves of a plant and eliciting a self-defense response to a pathogen.

2. The method of claim 1, wherein the first component comprises 24-Epibrassinolide.

3. The method of claim 1, wherein the Chitin’s derivatives comprise Chitin oligosaccharides.

4. The method of claim 1, wherein the Chitin’s derivatives are generated from a reaction of acylation, alkylation, sulfation, hydroxylation, quaternization, esterification, graft copolymerization, or etherification.

5. The method of claim 1, wherein the Chitosan’s derivatives comprise Chitosan oligosaccharides.

6. The method of claim 1, wherein the Chitosan’s derivatives are generated from acylation, alkylation, sulfation, hydroxylation, quaternization, esterification, graft copolymerization, or etherification.

7. The method of claim 1, wherein the fungal, bacterial and viral diseases comprise Cercospora leaf spots, downy mildews, powdery mildews or Botrytis diseases.

8. The method of claim 1, wherein a concentration of the first compound in the application solution is 0.001 - 10 ppm.

9. The method of claim 1, wherein a concentration of the first compound in the solution is 0.025 - 0.1 ppm.

10. The method of claim 1, wherein a concentration of the second compound in the solution is 1 - 100 ppm.

11. The method of claim 1, wherein a concentration of the second compound in the solution is 10 - 80 ppm.

12. The method of claim 1, further comprising applying the solution to the soil multiple applications with irrigation water starting from seeding and after.

13. The method of claim 1, further comprising applying the solution on the leaves of the plant with multiple foliar applications starting from a leaf development stage or right-after.

14. The method of claim 1, further comprising applying the solution preventively before an occurrence of biotic stress.

15. The method of claim 14, further applying the solution on the leaves of the plant with additional applications at an interval of every 10-14 day after a first two applications.

16. A method of seed treatment comprising:
(a) preparing a seed treatment solution comprising:
i) a first component selected from a group of a Brassinosteroids (BRs) family; and
ii) one or more of second components selected from a group of Chitin, Chitin’s derivatives, Chitosan, or Chitosan’s derivatives; and
(b) applying the seed treatment solution to seeds in a container.

17. The method of claim 16, further comprising treating the seeds through a commercial seed treatment equipment or a grower’s hopper box.

18. The method of claim 16, wherein the first component comprises 24-Epibrassinolide.

19. The method of claim 16, wherein the Chitin’s derivatives comprise Chitin oligosaccharides.

20. The method of claim 26, wherein the Chitosan’s derivatives comprise Chitosan oligosaccharides.

21. A plant protection solution comprises:
a) a first component selected from a group of a Brassinosteroids (BRs) family;
b) one or more of a second components selected from a group of Chitin, Chitin’s derivatives, Chitosan, and Chitosan’s derivatives; and
c) a water based solution containing the first component and the one or more of the second component as a main active ingredients in the water based solution.

22. The plant protection solution of claim 21, wherein the water-based solution comprises the first component and the one or more of the second component as the only active ingredients in the water based solution.

23. The plant protection solution of claim 21, wherein the first component comprises 24-Epibrassinolide.

24. The plant protection solution of claim 21, wherein the Chitin’s derivatives comprise Chitin oligosaccharides.

25. The plant protection solution of claim 21, wherein the Chitosan’s derivatives comprise Chitosan oligosaccharides.
